(19) United States
(12) Patent Application Publication
(10) Pub. No.: US 2012/0025790 A1
(43) Pub. Date: Feb. 2, 2012

(54) ELECTRONIC CIRCUIT, CIRCUIT APPARATUS, TEST SYSTEM, CONTROL METHOD OF THE ELECTRONIC CIRCUIT

(75) Inventors: Koichiro Noguchi, Tokyo (JP); Koichi Nose, Tokyo (JP); Yoshihiro Nakagawa, Tokyo (JP); Masayuki Mizuno, Tokyo (JP)

(73) Assignee: NEC CORPORATION, Tokyo (JP)

(21) Appl. No.: 13/146,806

(22) PCT Filed: Feb. 9, 2010
(86) PCT No.: PCT/JP2010/051895

§ 371 Date: Sep. 22, 2011

(30) Foreign Application Priority Data
Feb. 9, 2009 (JP) 2009-027205

(51) Int. Cl. G05F 1/10

(52) U.S. Cl. 323/265

(57) ABSTRACT

An electronic circuit includes: a first power line capable of supplying power; a second power line capable of supplying power independently from the first power line; a main circuit connected to the second power line; a detector that detects the supply of power from the first power line or the second power line; and a controller connected to the first power line and the second power line, wherein the controller controls a voltage or a current supplied from the first power line and supplies the voltage or the current to the main circuit when the detector detects supply of power from the first power line.

### TECHNICAL FIELD

The present invention relates to an electronic circuit and a technique for testing the electronic circuit.

### BACKGROUND ART

Along with a refinement of a manufacturing technique of an electronic circuit and high integration of an element, signal interference between wires, dynamic power change, and noise are generated. Therefore, there are problems that the reliability of a signal is reduced, and the performance of the entire chips is degraded.

To solve the problems related to the power source, Patent Literature 1 discloses a method of inserting a power control circuit, such as a regulator, between a power source and a circuit to be tested and reducing fluctuation (vibration) of power.

FIG. 11 shows a structure of a general chip including a power control circuit. The chip comprises a control element for power, a main circuit, and an auxiliary circuit. The control element and the auxiliary circuit are connected to power line VDD1, and an output terminal of the control element is connected to power line VDD2 that supplies power to the main circuit. An external power apparatus applies a voltage to power line VDD1 to eliminate fluctuation in power consumption of the chip (electronic circuit), such as during a test.

Meanwhile, FIG. 1 of Patent Literature 2 describes a configuration including dual-system power input terminals to allow selecting whether to supply power to a main circuit through a power control circuit or whether to supply power to a main circuit without using the power control circuit.

### CITATION LIST

### Patent Literature

Patent Literature 1: JP2008-060444A
Patent Literature 2: JP2005-086928A

### SUMMARY OF INVENTION

### Technical Problem

However, in the electronic circuit described in Patent Literature 1, power is supplied to power line VDD1 in the actual operation of the electronic circuit after shipment. Therefore, power consumption of the chip may increase in the electronic circuit described in Patent Literature 1 during the actual operation of the electronic circuit. This is due to the reason that at least a leak current always flows into the control circuit for power and the auxiliary circuit.

To achieve low power consumption and power stabilization, as required, one approach that can be contemplated would be to separately prepare a chip that includes a power control circuit, as shown in FIG. 11, that would be used to prioritize power fluctuation reduction over a reduction in consumed power, and to separately prepare a chip that comprises only a main circuit that would be used to prioritize power reduction over power fluctuation.

However, separate masks need to be prepared to prepare different kinds of chips varieties, and the development cost increases. Therefore, only a chip that includes a power control circuit as shown in FIG. 1 is prepared, and when use of the power control circuit is not required, the chip operates by minimizing the supply of power to the power control circuit and the auxiliary circuit. Therefore, power consumption by the unused power control circuit or auxiliary circuit cannot be prevented in the electronic circuit described in Patent Literature 1.

Meanwhile, according to the electronic circuit described in Patent Literature 2, whether to supply power to the main circuit through the power control circuit or whether to supply power to the main circuit without using the power control circuit can be selected. However, it is not possible to detect to which power input terminal the power source is connected in order to control the mode of the power control circuit in accordance with the detected result.

An object of the present invention is to provide a technique for reducing power consumption in an electronic circuit during the actual operation by automatically determining the state of power supply and by controlling the power control circuit based on the state.

### Solution to Problem

To attain the object, the present invention provides an electronic circuit comprising: a first power line capable of supplying power; a second power line capable of supplying power independently from the first power line; a main circuit connected to the second power line; a detector that detects the supply of power from the first power line or the second power line; and a controller connected to the first power line and the second power line, wherein the controller controls a voltage or a current supplied from the first power line and supplies the voltage or the current to the main circuit when the detector detects supply of power from the first power line.

The present invention provides a circuit apparatus comprising electronic circuits that share the first power line.

The present invention provides a control method of an electronic circuit, the method comprising the steps of: (a) detecting the supply of power from a first power line capable of supplying power or a second power line capable of supplying power independently from the first power line; and (b) controlling a potential or a current supplied from the first power line and supplying the potential or the current to a main circuit when supply of power from the first power line is detected at detecting step (a).

### Advantageous Effects of Invention

According to the present invention, an electronic circuit can automatically determine the state of power supply and control the voltage/current based on the state.

### BRIEF DESCRIPTION OF DRAWINGS

FIG. 1 is a block diagram showing a configuration of a chip of a first exemplary embodiment.

FIG. 2 is a connection diagram for explaining a test method of the first exemplary embodiment.

FIG. 3 is a connection diagram for explaining a test method of the first exemplary embodiment.

FIG. 4 is a connection diagram for explaining a test method of the first exemplary embodiment.

FIG. 5 is a connection diagram of chip 1 during shipment of a product of the first exemplary embodiment.

FIG. 6 is a block diagram showing a configuration of a chip of a modified example.

FIG. 7 is a block diagram showing a configuration of a wafer of a second exemplary embodiment.

FIG. 8 is a block diagram showing a configuration of a chip of a third exemplary embodiment.

FIG. 9 is a block diagram showing a configuration of a chip of a fourth exemplary embodiment.

FIG. 10 is a block diagram showing a configuration of a chip of a modified example.

FIG. 11 is a connection diagram for explaining a general test method of a chip.

### DESCRIPTION OF EMBODIMENTS

### First Exemplary Embodiment

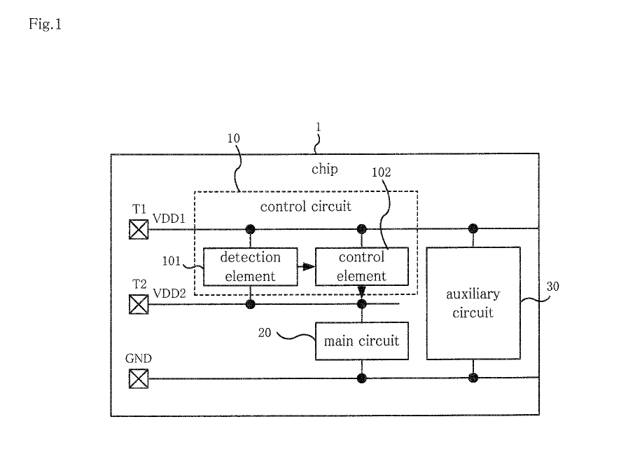

A first exemplary embodiment for carrying out the present invention will be described in detail with reference to the drawings. FIG. 1 is a block diagram showing a configuration of chip 1 of the present exemplary embodiment. With reference to FIG. 1, chip 1 includes control circuit 10, main circuit 20, auxiliary circuit 30, and power lines VDD1 (first power line) and VDD2 (second power line).

External terminals T1 and T2 are arranged at ends of power lines VDD1 and VDD2 as necessary to connect an external power source. Input terminals of control circuit 10 and auxiliary circuit 30 are connected to external terminal T1 through power line VDD1. An output terminal of control circuit 10 and an input terminal of main circuit 20 are connected to external terminal T2 through power line VDD2.

Output terminals of main circuit 20 and auxiliary circuit 30 are connected to a ground terminal (GND).

Control circuit 10 is a circuit for controlling the voltage/current supplied to main circuit 20 and includes detection element 101 (detector) and control element 102 (controller).

Power lines VDD1 and VDD2 serve as inputs of detection element 101, and detection element 101 detects connection of an external power source to either external terminals T1 or T2. For example, detection element 101 detects connection of an external power source when a voltage greater than a predetermined value is applied to external terminal T21. Detection element 101 outputs the detected result to control element 102 as a control signal.

When detection element 101 detects connection of an external power source to external terminal T1, control element 102 receives a control signal from detection element 101 and controls the voltage/current supplied to main circuit 20. Control element 102 is, for example, a regulator.

When detection element 101 detects connection of an external power source to external terminal T2, control element 102 receives a control signal from detection element 101 and enters a blocked state, in which a current does not flow in a direction from VDD2 to VDD1. This can prevent leak current from flowing through control element 102, auxiliary circuit 30, and the like and reduce power consumption.

Main circuit 20 is a circuit to be tested. Auxiliary circuit 30 is a circuit connected to power line VDD1, other than main circuit 20. Auxiliary circuit 30 is, for example, a BIST (Built In Self Test) circuit that has a tester function. A test pattern indicating an execution procedure of a test for main circuit 20, a circuit that compares a reference value and a measurement value, and the like are incorporated into the BIST circuit.

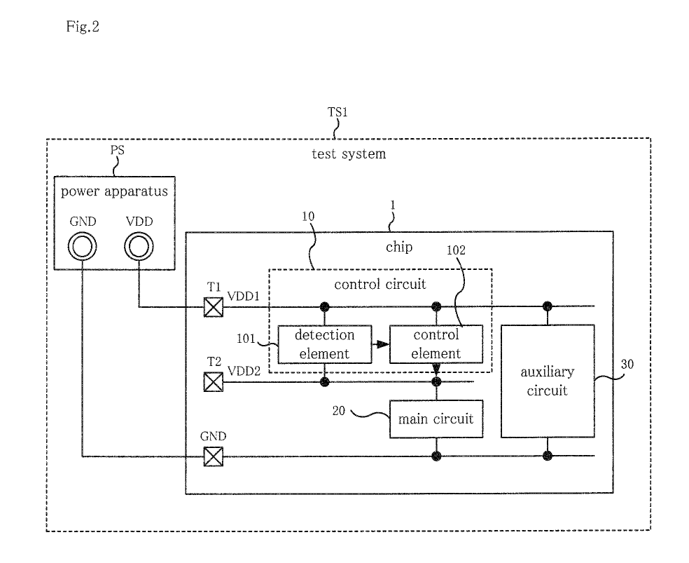

A method of performing a predetermined test for chip 1 will be described with reference to FIGS. 2 to 4. FIG. 2 is an overall view of test system TS1 for testing chip 1. With reference to FIG. 2, test system TS1 includes chip 1 and power apparatus PS. As shown in FIG. 2, power terminal (VDD) of power apparatus PS is connected to external terminal T1. Ground terminal (GND) of power apparatus PS is connected to ground terminal (GND) of chip 1.

The potential of external terminal T1 becomes greater than a predetermined value when power apparatus PS is connected to external terminal T1. Therefore, control element 102 controls the voltage/current supplied to main circuit 20 based on the output of detection element 101.

When the power supply by power apparatus PS is started, the test for main circuit 20 is performed in accordance with the test pattern incorporated into auxiliary circuit 30. The vibration of the power source is reduced by the action of control element 102. Therefore, the operator can accurately and efficiently perform the test.

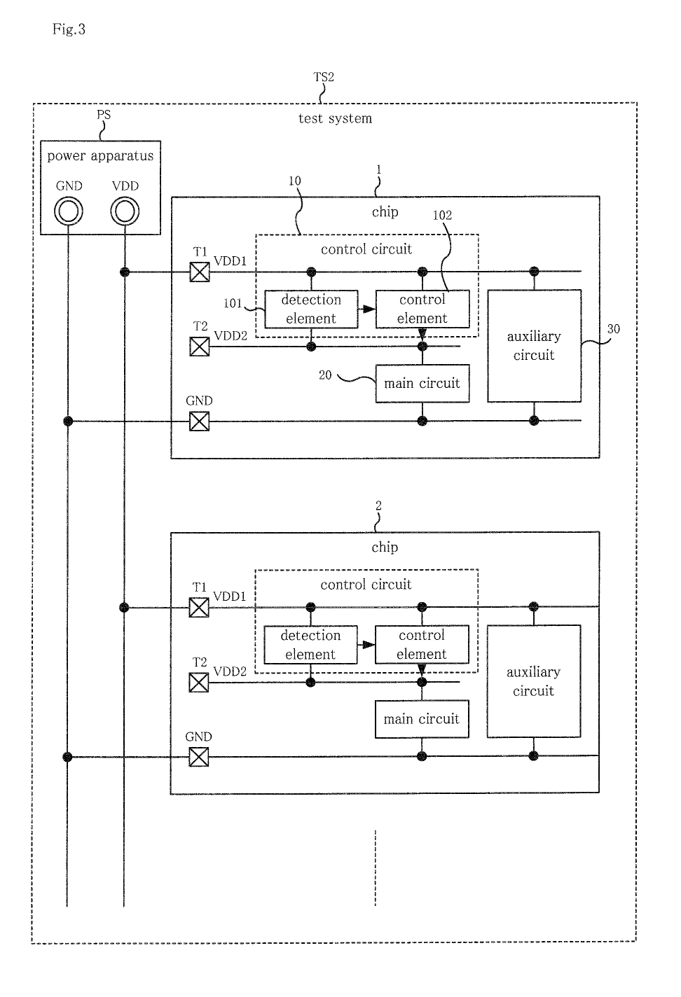

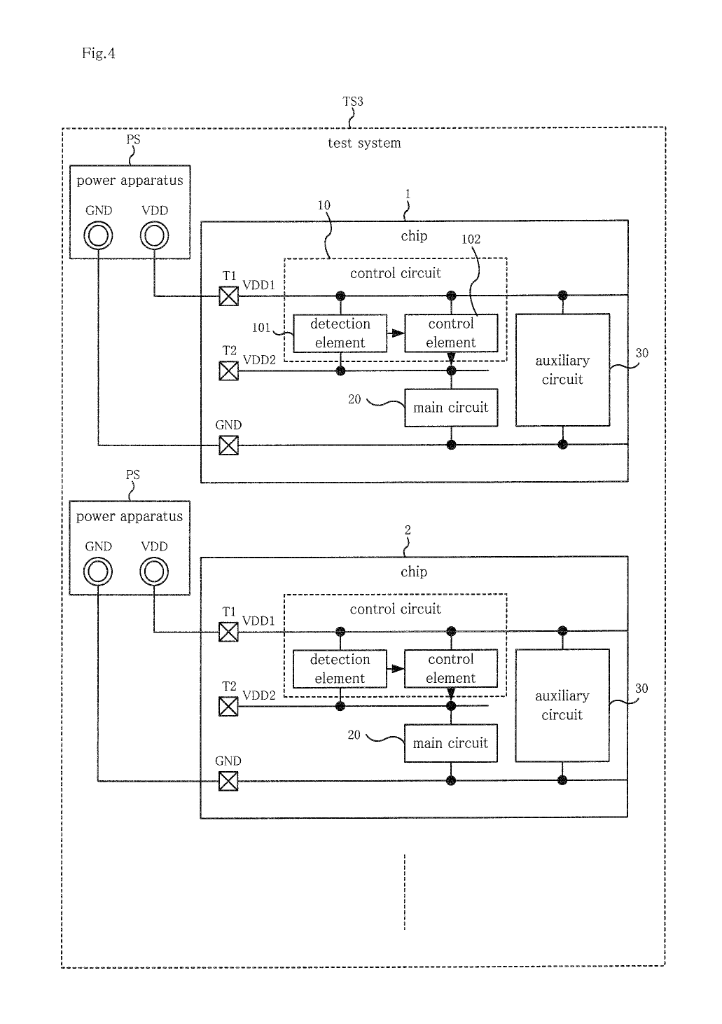

FIGS. 3 and 4 are overall views showing configurations of test systems TS2 and TS3 for testing chips with the same configuration as chip 1. With reference to FIG. 3, test system TS2 includes chips with the same configuration as chip 1 and power apparatus PS. External terminal (T1) of each chip is short-circuited and connected to a power terminal of power apparatus PS. The connection this way can reduce the number of channels of the power apparatus that are necessary for the test. The test for the chips can be performed simultaneously, and the time required for the entire tests can be reduced. As a result, the cost of the test is reduced.

With reference to FIG. 4, test system TS3 includes sets, each comprising a chip with the same configuration as chip 1 and power apparatus PS. In each set, external terminal (T1) of the chip is connected to the power terminal of corresponding power apparatus (PS). In the system of short-circuiting external terminal T1 for connection with the power source, as shown in FIG. 3, noise may be generated in voltage/current signals because electric fields generated by operation of the chips affect each other. The noise is not generated as a result of the connection of FIG. 4. Therefore, a more accurate test is performed for each chip.

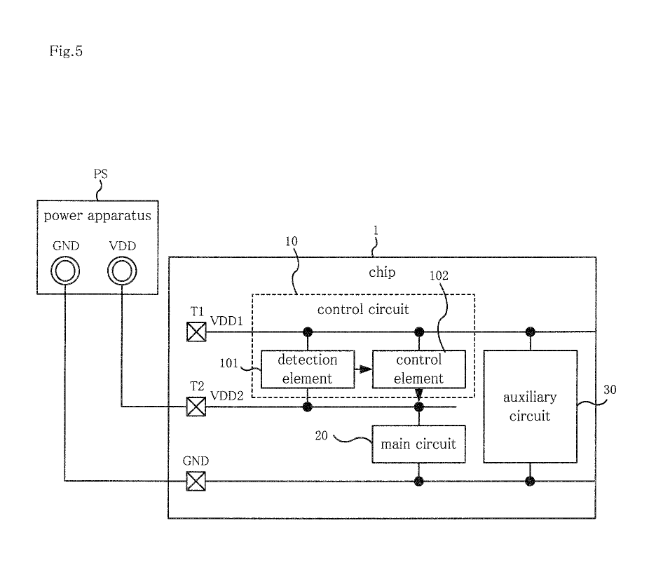

FIG. 5 is a connection diagram between chip 1 and power apparatus PS during actual operation of the chip after the test. With reference to FIG. 5, power terminal (VDD) of power apparatus PS and external terminal T1 are connected. As described, control element 102 does not apply a current from external terminal T2 to external terminal T1. Therefore, the connection of power apparatus PS to external power source T1 can reduce leak current from flowing into control circuit 10 and auxiliary circuit 30. As a result, the consumed power during operation of chip 1 is reduced.

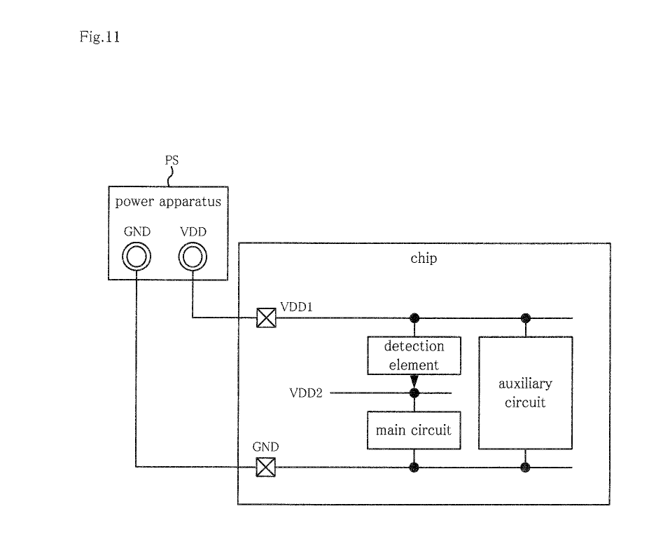

Meanwhile, if external terminal T2 and detection element 101 are not arranged as shown in FIG. 11, power consumption increases by the amount of power consumed by the control element and the auxiliary circuit during actual operation of the chip after the test. Power consumption does not increase if a chip that includes the control circuit and the auxiliary circuit and a chip that does not include the control circuit and the auxiliary circuit are separately prepared. However, an extra chip needs to be manufactured, and the cost increases.

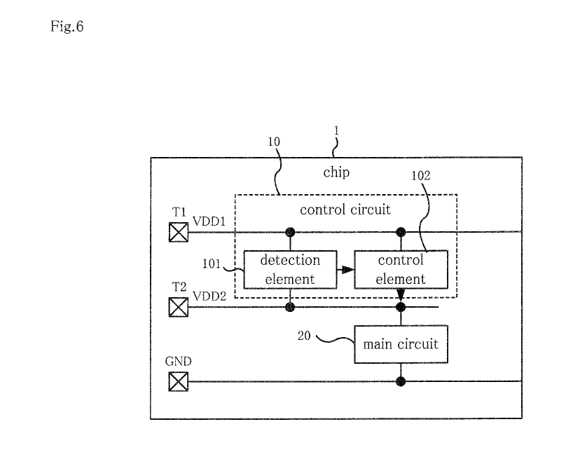

Although auxiliary circuit 30 is provided in the present exemplary embodiment, if the purpose is just to improve the reliability of the power source, then auxiliary circuit 30 does not need to be provided, as shown in FIG. 6, and auxiliary circuit 30 is not needed for conducting a test.

Although control circuit 10 includes only detection element 101 and control element 102 in the present exemplary embodiment, it is obvious that other devices can be arranged on control circuit 10.

Although a regulator is illustrated as control element 102 in the present exemplary embodiment, another device may be used as control element 102 if a function of controlling the power supplied by power line VDD2 is included.

Although the power source is connected to power terminal T2 during actual operation of the chip in the present exemplary embodiment, the operator may connect the power source to power terminal T1 even during the actual operation if the reliability of the power source needs to be improved.

Although control element 102 supplies a controlled power source to main circuit 20 through power line VDD2 in the present exemplary embodiment, control element 102 may supply controlled voltage/current to main circuit 20 without involving power line VDD2.

As described, according to the present exemplary embodiment, control element 102 is controlled by using detection element 101 that automatically determines from among which of power line VDD1 (first power line) and power line VDD2 (second power line) the power is supplied. Therefore, an operation state, in which control element 102 automatically reduces the power fluctuation, can be set when the power is supplied from power line VDD1, and control element 102 can be automatically put into a blocked state when the power is supplied from power line VDD2. As a result, a leak current flowing into control element 102 and the like can be prevented, and power consumption can be reduced when power is supplied from power line VDD2.

Detection element 101 detects connection of an external power source when voltage greater than the predetermined value is applied to power line VDD1. Therefore, the configuration of detection element 101 can be simple.

Since chip 1 includes auxiliary circuit 30 for conducting a test, the test for chip 1 is facilitated.

Control circuit 10 can control the power if the power is supplied to power line VDD1. Therefore, the user can perform a predetermined test for main circuit 20 to control the power.

When chips are tested, the number of channels of the power apparatus necessary for the tests can be reduced if external terminal T1 (power line VDD1) of each chip is short-circuited and connected to the power source. The chips can be simultaneously tested, and the time required for the tests can be reduced. As a result, the cost for the tests is reduced.

When chips are tested, the operator can perform more accurate test for each chip if the power source is connected to each external terminal T1 (power line VDD1).

### Second Exemplary Embodiment

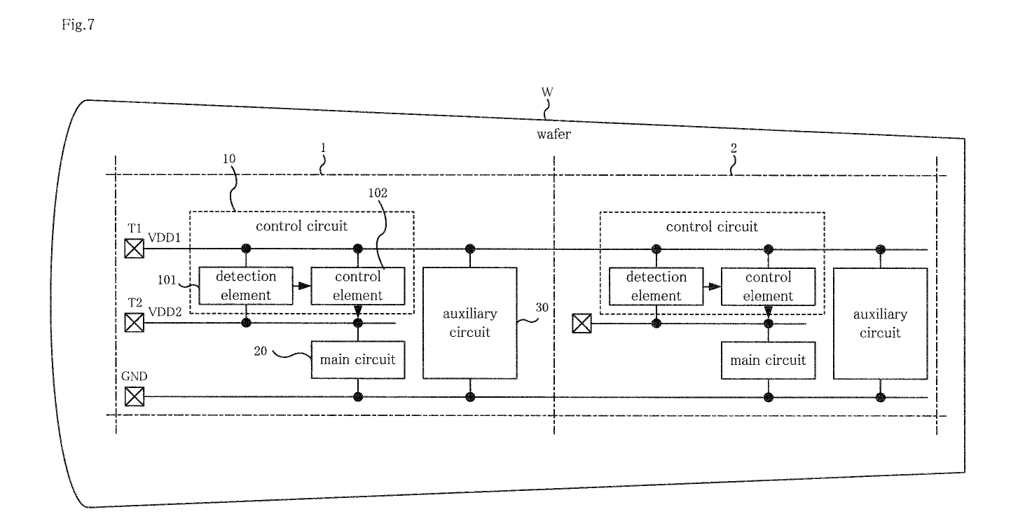

A second exemplary embodiment will be described with reference to FIG. 7. FIG. 7 is an overall view showing a configuration of wafer W of the present exemplary embodiment. With reference to FIG. 7, wafer W is provided with chips that have the same configuration as chip 1 of the first exemplary embodiment, and the chips share external terminal T1. Alternate long and short lines in FIG. 7 are dicing lines. A predetermined machine cuts wafer W along the dicing lines to separate wafer W into chips.

The operator can connect the power source to external terminal T1 before the separation of wafer W into chips, and the test system can simultaneously test the chips as shown in FIG. 3.

Alternatively, the power source can be connected to each external terminal T1 as shown in FIG. 4 after the separation of wafer W into chips, and the test system can perform accurate tests.

As described, according to the present exemplary embodiment, the formation of the chips on wafer W can reduce the manufacturing cost, compared to when the chips are individually manufactured.

The cost of the tests can be reduced by performing the tests by supplying the power source to power line VDD1 through external terminal T1 before the separation of wafer W into chips.

The chips are more accurately tested by performing the tests by supplying the power source to each power line VDD1 through each external terminal T1 after the separation of wafer W into chips.

### Third Exemplary Embodiment

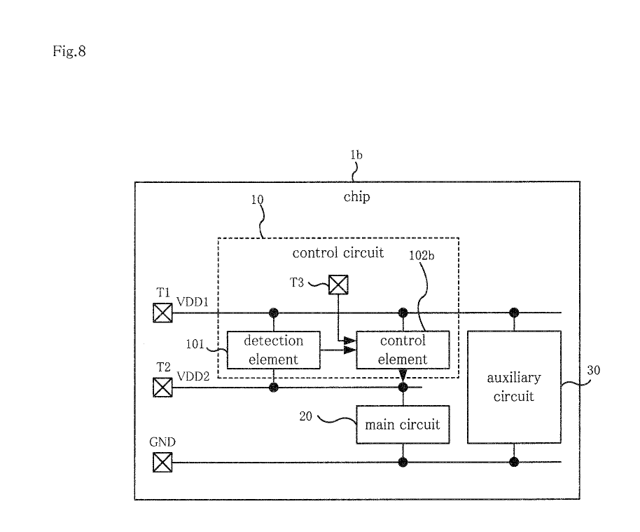

A third exemplary embodiment will be described with reference to FIG. 8. FIG. 8 is a block diagram showing a configuration of chip 1b of the present exemplary embodiment. With reference to FIG. 8, chip 1b is different from chip 1 of the first exemplary embodiment in that chip 1b includes control element 102b in place of control element 102 and further includes external terminal T3.

Control element 102b controls the voltage and the like to main circuit 20 when detection element 101 detects connection of an external power source to external terminal T1 and when voltage greater than a predetermined value is applied to external terminal T3. For example, voltage greater than the predetermined value is applied to external terminal T3 when the user performs a predetermined operation.

Control element 102b does not apply a current from external terminal T2 to external terminal T1 when the external power source is not connected to external terminal T1 or when voltage greater than the predetermined value is not applied to external terminal T3.

As described, according to the present exemplary embodiment, chip 1b controls the voltage and the like to main circuit 20 when detection element 101 detects connection of an external power source to external terminal T1 and when voltage greater than the predetermined value is applied to external terminal T3. Therefore, as a result of the application of voltage to external terminal T3, the test system can start the test at arbitrary timing, and the test is facilitated.

### Fourth Exemplary Embodiment

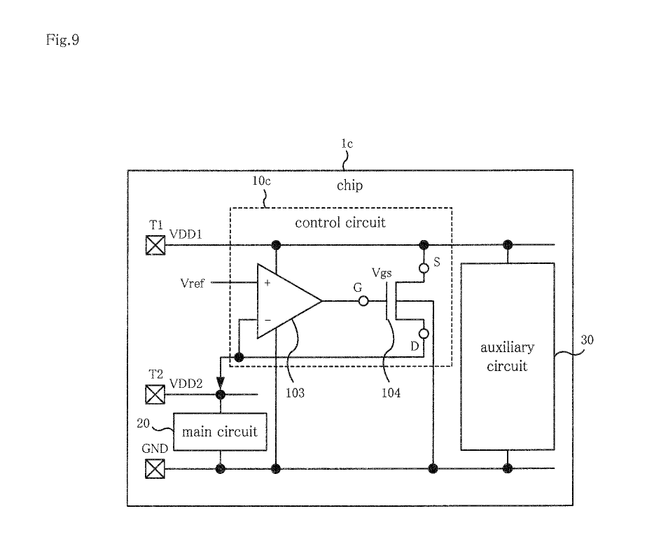

A fourth exemplary embodiment will be described with reference to FIG. 9. FIG. 9 is a block diagram showing a configuration of chip 1c of the present exemplary embodiment. With reference to FIG. 9, chip 1c is different from chip 1 of the first exemplary embodiment in that chip 1c includes differential amplifier 103 and driver transistor 104 in place of detection element 101 and control element 102.

Differential amplifier 103, activated by a power source connected to power line VDD1, amplifies a voltage difference between predetermined reference voltage Vref and voltage applied to external terminal T2 and outputs the voltage difference to driver transistor 104. Differential amplifier 103 is, for example, a non-inverting amplifying circuit, in which reference voltage Vref is applied to non-inverting input terminal (+), an inverting effective terminal is connected to external terminal T2 through power line VDD2, and an output terminal is connected to driver transistor 104. Differential amplifier 103 amplifies the voltage difference between reference voltage Vref and the voltage at external terminal T1 to set reference voltage Vref to a voltage at a value sufficient to drive driver transistor 104.

Driver transistor 104 is a transistor that turns on when the voltage amplified by differential amplifier 103 is greater than a predetermined value. Driver transistor 104 is, for example, an N-type field effect transistor (FET), in which gate terminal (G) is connected to differential amplifier 103, source terminal (S) is connected to power line VDD1 (external terminal T1), drain terminal (D) is connected to inverting input terminal (−) of differential amplifier 103, and a back gate terminal is connected to a ground terminal.

An operation of chip 1c when the power source is not connected to external terminal T2 but is connected to external terminal T1 will be described. In this case, differential amplifier 103 is activated to amplify the voltage difference between the voltage at external terminal T2 and reference voltage Vref. As a result, the output voltage of differential amplifier 103 becomes greater than the pinch-off voltage, and driver transistor 104 is turned on. Driver transistor 104 then operates as a regulator. More specifically, driver transistor 104 controls gate-source voltage (Vgs) in accordance with the voltage difference between the gate voltage, i.e. voltage at external terminal T2, and reference voltage Vref.

Power line VDD2 becomes a floating node when driver transistor 104 is driven, and the voltage is not determined However, the output (drain terminal) of driver transistor 104 is fed back to differential amplifier 103 through inverting effective terminal (−) of the differential amplifier. Therefore, the entire control circuit 10 is operated so that the potentials of reference voltage Vref and gate-source voltage (Vgs) become the same. If the voltage in power line VDD2 fluctuates, driver transistor 104 operates to cancel the fluctuation. Therefore, control circuit 10 can supply stable power to main circuit 20 through power line VDD2.

An operation of chip 1c when the power source is not connected to external terminal T1 but is connected to external terminal T2 will be described in accordance with the voltage level applied to external terminal T2.

A case in which voltage (Vvdd2) in power line VDD2 (external terminal T2) is higher than voltage (Vvdd1) in power line VDD1 (external terminal T1) will be described (Vvdd2>Vvdd1). In this case, source-gate voltage (Vgs) of driver transistor 104 is not greater than 0 (V), and driver transistor 104 is turned off The reason why source-gate voltage (Vgs) of driver transistor 104 is not greater than 0 is because the power source of differential amplifier 103 is power line VDD1, and source-gate voltage (Vgs) is not greater than Vvdd1.

Power line VDD1 becomes a floating node when a power source is connected to external terminal T2. Therefore, voltage (Vvdd2) in dd1 power line VDD2 (external terminal T2) may be lower than voltage (Vvdd1) in power line VDD1 (external terminal T1) (Vvdd2<Vvdd1). Even in this case, driver transistor 104 is turned off if the following Expression (1) is satisfied. Therefore, a blocked state is set, in which main circuit 20 is blocked from control circuit 10.

Vgs<Vvdd2+Vth (1)

In Expression (1), Vth denotes a threshold of a voltage that drives driver transistor 104.

Driver transistor 104 is turned on if the following Expression (2) is satisfied, and a current flows from power line VDD2 to power line VDD1. However, since power line VDD1 is a floating node, current flows only by the amount of accumulated charge in a parasitic capacitor. As a result, main circuit 20 enters the blocked state after current has flowed trough main circuit 20 in accordance with the amount of charge, even if Expression (2) is satisfied.

Vgs>Vvdd2+Vth (2)

In this way, driver transistor 104 is turned off unless the power source is connected to external terminal T1, and current does not flow from power line VDD2 to power line VDD1. Therefore, control circuit 10 can block main circuit 20.

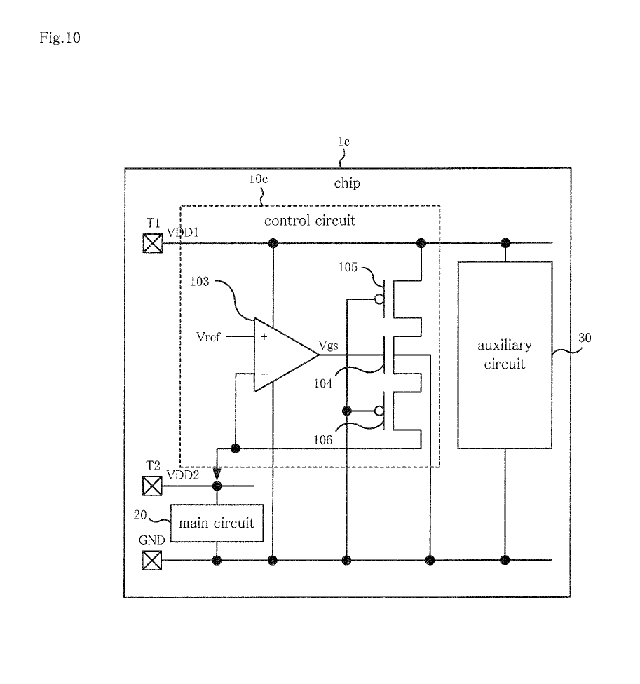

Although only differential amplifier 103 and driver transistor 104 are arranged in control circuit 10 in the present exemplary embodiment, it is obvious that other devices can be set to the control circuit. For example, P-type field effect transistors 105 and 106 can be inserted to both ends of driver transistor 104 as shown in FIG. 10. The configuration can prevent electrostatic breakdown of driver transistor 104 compared to when the source terminal and the drain terminal of driver transistor 104 are directly connected to the power source.

Although an N-type field effect transistor is used as driver transistor 104 in the present exemplary embodiment, it is obvious that a P-type field effect transistor, a bipolar transistor, and the like can be used.

As described, according to the present exemplary embodiment, differential amplifier 103 (detector) in chip 1c (electronic circuit) amplifies the voltage difference between the voltage in power line VDD2 (second power line) and the predetermined reference voltage if voltage greater than the predetermined value is applied to power line VDD1 (first power line).

If the voltage difference amplified by differential amplifier 103 is greater than the predetermined value, driver transistor 104 (controller) controls the voltage/current supplied to the main circuit in accordance with the amplified voltage difference. Therefore, power is not consumed by the control circuit during the actual operation if power is supplied to the first power line during the test and supplied to the second power line during the actual operation, and thus power consumption of the electronic circuit is reduced.

Driver transistor 104 generates reverse bias in the direction from external terminal T1 to external terminal T2. Therefore, current does not flow into control circuit 10 even if the power source is connected to external terminal T2, and thus consumed power is reduced.

This application claims the benefit of priority based on Japanese Patent Application No. 2009-027205 filed Feb. 9, 2009, the entire disclosure of which is hereby incorporated by reference.

### REFERENCE SIGNS LIST

1, 2 chips
10 control circuit
20 main circuit
30 auxiliary circuit
101 detection element
102 control element
103 differential amplifier
104 driver transistor
105, 106 field effect transistors
G gate terminal
S source terminal
D drain terminal
GND ground terminal
PS power apparatus
T1, T2, T3 external terminals
TS1 to TS3 test systems
VDD power terminal
VDD1, VDD2 power lines
Vgs gate-source voltage
Vref reference voltage
W wafer

1. An electronic circuit comprising:
a first power line;
a second power line at a potential different from that of said first power line;
a main circuit connected to said second power line;
a detection element that detects a potential or a current of said first power line and said second power line; and
a power control element connected to said first power line and said second power line, wherein
said power control element controls an application state of a voltage or a current to said second power line according to an output from said detection element.

2. The electronic circuit according to claim 1, wherein
when said detection element detects application of a potential or a current greater than a predetermined value to said first power line,
said power control element outputs an arbitrary potential to said second power line, and
when said detection element detects application of a potential or a current greater than a predetermined value to said second power line,
said power control element puts said first power line and said second power line into an electrically open state.

3. The electronic circuit according to claim 1, wherein
said power control element comprises a second control signal input, and
when said detection element detects application of a potential or a current greater than the predetermined value to said first power line,
said power control element outputs a voltage signal at the same potential as that of the second control signal to said second power line.

4. The electronic circuit according to claim 3, wherein
to set an output potential equal to the potential of the second control signal, said power control element
decreases the output potential if the potential of the second control signal is higher than the output potential and
increases the output potential if the potential of the second control signal is lower than the output potential.

5. The electronic circuit according to claim 3, wherein
said detection element and said power control element comprise:
an operational amplifier, in which said first power line serves as a power source and said second power line and the second control signal serve as inputs; and
a driver circuit, in which said first power line serves as a power source, an output of said operational amplifier serves as an input, and said second power line serves as an output.

6. The electronic circuit according to claim 5, wherein
in a configuration in which said driver circuit comprises a first P-type transistor, a second P-type transistor, and an N-type transistor,
a source terminal of said first P-type transistor is connected to said first power line, a gate terminal is connected to a ground, a drain terminal is connected to a drain terminal of said N-type transistor,
a gate terminal of said N-type transistor is connected to an output of said operational amplifier, a source terminal is connected to a source terminal of said second P-type transistor,
a gate terminal of said second P-type transistor is connected to the ground, and a drain terminal is connected to said second power line.

7. The electronic circuit according to claim 1, comprising
a second main circuit that handles said first power line as a power source and that is configured differently from said main circuit.

8. A circuit apparatus comprising
the electronic circuits according to claim 1 that share said first power line.

9. A test system comprising:
the electronic circuit according to claim 1; and
an external power source connected to said first power line.

10. A test system comprising:
the electronic circuits according to claim 1; and
an external power source short-circuiting and connecting each of said first power lines.

11. A test system comprising sets, each set comprising:
the electronic circuit according to claim 1; and
an external power source connected to said first power line.

12. A test system comprising:
the circuit apparatus according to claim 8; and
an external power source connected to said first power line.

13. A control method of an electronic circuit, the method comprising the steps of:
(a) detecting the supply of power from a first power line capable of supplying power or a second power line capable of supplying power independently from said first power line; and
(b) controlling a potential or a current supplied from said first power line and supplying the potential or the current to a main circuit when supply of power from said first power line is detected in said detecting step (a).

14. The control method of an electronic circuit according to claim 13, the method comprising the step of
(b′) supplying a potential or a current supplied from said second power line to said main circuit when supply of power from said second power line is detected in said detecting step (a).
